(19) United States
(12) Patent Application Publication
(10) Pub. No.: US 2024/0312707 A1
(43) Pub. Date: Sep. 19, 2024

(54) Composite Hydrophilic Membrane Electrode, Membrane Capacitor Cell, Preparation Method and use Thereof

(71) Applicant: BEIJING UNIVERSITY OF CHEMICAL TECHNOLOGY, BEIJING (CN)

(72) Inventors: Xu XIANG, Beijing (CN); Junxiang ZHANG, Beijing (CN); Xue DUAN, Beijing (CN)

(73) Assignee: BEIJING UNIVERSITY OF CHEMICAL TECHNOLOGY, BEIJING (CN)

(21) Appl. No.: 18/346,265

(22) Filed: Jul. 2, 2023

(30) Foreign Application Priority Data
Dec. 12, 2022 (CN) 202211597829.5

(51) Int. Cl. H01G 4/005

(52) U.S. Cl. CPC H01G 4/005

(57) ABSTRACT

The present disclosure provides a composite hydrophilic membrane electrode, a membrane capacitor cell, a preparation method and use thereof. The method for preparing the composite hydrophilic membrane electrode includes: mixing Li₂CO₃ with TiO₂ evenly to obtain a mixture, and baking the mixture to obtain a Li₂TiO₃ precursor; mixing the Li₂TiO₃ precursor with graphene oxide evenly to obtain a Li₂TiO₃/graphene oxide composite material; calcining the Li₂TiO₃/graphene oxide composite material to obtain a Li₂TiO₃/reduced graphene oxide composite material; modifying the Li₂TiO₃/reduced graphene oxide composite material with tannic acid to obtain a modified active electrode material; and mixing the modified active electrode material with a solvent to obtain an active electrode slurry, applying the active electrode slurry onto a titanium plate, and baking the active electrode slurry to obtain the composite hydrophilic membrane electrode.

### CROSS-REFERENCE TO RELATED APPLICATIONS

This application claims priority to Chinese Patent Application No. 202211597829.5 with a filing date of Dec. 12, 2022. The content of the aforementioned application, including any intervening amendments thereto, is incorporated herein by reference.

### TECHNICAL FIELD

The present disclosure relates to the field of lithium extraction technology, in particular to a composite hydrophilic membrane electrode, a membrane capacitor cell, a preparation method thereof, and use thereof.

### BACKGROUND

Lithium has been widely used in various fields, e.g., new energy battery, catalysis, atomic energy and aerospace, due to such advantages as being chemically active, large specific heat capacity, low expansion coefficient, highest electro-chemical activity and lowest redox potential. Abundant lithium resources are contained in salt lake brine, but at a low concentration of lithium ions and a high concentration of foreign ions. Hence, it is very difficult to extract the lithium ions, and the quantity of the extracted lithium ions is low.

Membrane separation is considered as a promising and environment-friendly lithium recycling method due to such advantages as high energy efficiency and being easy to operate. Monovalent ions are extracted through a nanofiltration membrane on the basis of steric hindrance and Gibbs-Donnan effect. However, in actual use, it is impossible to completely separate the lithium ions from magnesium ions through the nanofiltration membrane, and a separation factor of Li⁺ relative to Mg²⁺ is 2.6 to 10.4. In addition, such a phenomenon as membrane fouling occurs after the nanofiltration membrane is used for a certain time period, and thereby the separation efficiency is deteriorated.

Electrodialysis is a technology where Li⁺ is separated from Mg²⁺ under the effect of an electric field on the basis of different diffusion rates of a monovalent cation and a divalent cation through an ion exchange membrane, with low power consumption, excellent selectivity to cations at different valence states, and a high lithium recycling rate. However, it is impossible to effectively extract Li⁺ in the presence of the other monovalent ions (e.g., Na⁺ or K⁺). A bipolar membrane is introduced, so as to break water down into H⁺ and OH⁻, and extract Li⁺ in the form of LiOH. Through the bipolar membrane, it is merely able to obtain a concentrated solution rather than the monovalent ions.

Supported liquid membrane separation is a technology where ions are selectively transmitted through a solvent in a membrane, with an ion recycling rate greater than 95%. However, a leakage of an organic solvent in the supported liquid membrane easily occurs, and a chemical reagent needs to be used for desorption.

For a membrane capacitor method, a selectively permeable membrane is used to selectively separate monovalent ions through electrostatic attraction, with an ionic sieve as an active electrode material. When this method is used to extract lithium from the salt lake brine, no acid is used, so it is environment-friendly. Currently, an adsorbent for extracting lithium includes a manganese ion sieve, a titanium ion sieve and an aluminium adsorbent, and the manganese ion sieve is most widely used as the active electrode material. However, when the manganese ion sieve is formed through pickling a lithium manganite precursor, a serious solution loss of manganese occurs, and it is necessary to reduce the solution loss through further modification.

Due to a special electron structure and stability of Ti⁴⁺, the titanium ion sieve has a smaller solution loss and higher chemical stability than the manganese ion sieve, so it has attracted more and more attentions. The titanium ion sieve mainly includes LiTiO₃ and Li₄Ti₅O₁₂. As compared with an ion sieve prepared with Li₄Ti₅O₁₂ as a precursor, a layered ion sieve prepared with LiTiO₃ as a precursor has a higher theoretical lithium ion adsorption capacity, and the preparation of the layered ion sieve is simple. However, during the extraction of lithium, the conductivity of the layered ion sieve is low. In addition, the flowability and permeability of powder are poor, so the powder easily moves together and thereby the lithium ion adsorption capacity is relatively low.

### SUMMARY OF PRESENT INVENTION

An object of the present disclosure is to provide a composite hydrophilic membrane electrode, a membrane capacitor cell, a preparation method and use thereof, so as to solve the problem in the related art where the lithium extraction capacity is low due to the low conductivity of the titanium ion sieve.

In one aspect, the present disclosure provides in some embodiments a method for preparing a composite hydrophilic membrane electrode, including: mixing Li₂CO₃ with TiO₂ evenly to obtain a mixture, and baking the mixture to obtain a Li₂TiO₃ precursor; mixing the Li₂TiO₃ precursor with graphene oxide evenly to obtain a Li₂TiO₃/graphene oxide composite material; calcining the Li₂TiO₃/graphene oxide composite material to obtain a Li₂TiO₃/reduced graphene oxide composite material; modifying the Li₂TiO₃/reduced graphene oxide composite material with tannic acid to obtain a modified active electrode material; and mixing the modified active electrode material with a solvent to obtain an active electrode slurry, applying the active electrode slurry onto a titanium plate, and baking the active electrode slurry to obtain the composite hydrophilic membrane electrode.

In a possible embodiment of the present disclosure, a molar ratio of Li₂CO₃ to TiO₂ is 1.9:2 to 2.2:2, and the mixture is baked at a temperature of 700° C. to 850° C. for 4 hours to 10 hours.

In a possible embodiment of the present disclosure, the mixing Li₂CO₃ with TiO₂ evenly to obtain the mixture includes adding Li₂CO₃ and TiO₂ into an ethanol solution, dispersing a resultant solution evenly through ultrasonic wave, filtering the resultant solution to obtain a filtered liquid, and drying the filtered liquid to obtain the mixture in the form of powder.

In a possible embodiment of the present disclosure, a mass ratio of the Li₂TiO₃ precursor to graphene oxide is 10:1 to 50:1, and graphene oxide is a graphene oxide dispersion.

In a possible embodiment of the present disclosure, the graphene oxide dispersion is an ethanol solution containing graphene oxide.

In a possible embodiment of the present disclosure, the mixing the Li₂TiO₃ precursor with graphene oxide evenly to obtain the Li₂TiO₃/graphene oxide composite material includes mixing the Li₂TiO₃ precursor with the graphene oxide dispersion evenly, filtering a resultant solution to obtain a filtered liquid, and drying the filtered liquid to obtain the Li₂TiO₃/graphene oxide composite material.

In a possible embodiment of the present disclosure, the Li₂TiO₃/graphene oxide composite material is calcined in a nitrogen atmosphere at a temperature of 500° C. to 700° C. for 1 hour to 3 hours.

In a possible embodiment of the present disclosure, prior to modifying the Li₂TiO₃/reduced graphene oxide composite material with tannic acid, the Li₂TiO₃/reduced graphene oxide composite material is processed with 0.1 mol/L to 0.5 mol/L hydrochloric acid at a temperature of 50° C. to 80° C. for 8 hours to 12 hours. The modifying the Li₂TiO₃/reduced graphene oxide composite material with tannic acid includes adding the Li₂TiO₃/reduced graphene oxide composite material into a Tris buffer solution with a pH value of 8.0, dispersing a resultant solution through ultrasonic wave for 30 minutes to 60 minutes, adding tannic acid and diethylenetriamine into the resultant solution to obtain a mixture, stirring the mixture for 1 hour to 6 hours, subjecting the mixture to centrifugal treatment, and washing the mixture to obtain the modified active electrode material. The Tris buffer solution is an aqueous solution of tris(hydroxymethyl) aminomethane modified with hydrochloric acid, and a mass ratio of the Li₂TiO₃/reduced graphene oxide composite material to the Tris buffer solution is 1:2.5 to 1:1.

In a possible embodiment of the present disclosure, a mass ratio of tannic acid to diethylenetriamine is 4:1.

In a possible embodiment of the present disclosure, a mass ratio of the Li₂TiO₃/reduced graphene oxide composite material to tannic acid is 1:1 to 1:0.02.

In a possible embodiment of the present disclosure, the solvent is a mixture of polyvinylidene fluoride and N,N-dimethylacetamide, or a mixture of glutaric dialdehyde and polyvinyl alcohol.

In a possible embodiment of the present disclosure, the modified active electrode material, polyvinylidene fluoride and N,N-dimethylacetamide are mixed at a mass ratio of 8:1:48.

In a possible embodiment of the present disclosure, the modified active electrode material, glutaric dialdehyde and polyvinyl alcohol are mixed at a mass ratio of 200:1:50.

In a possible embodiment of the present disclosure, the active electrode slurry is baked in a vacuum oven at a temperature of 50° C. to 60° C. for 12 hours to 24 hours.

In another aspect, the present disclosure provides in some embodiments a composite hydrophilic membrane electrode prepared through the above-mentioned method.

In yet another aspect, the present disclosure provides in some embodiments the use of the above-mentioned composite hydrophilic membrane electrode in the extraction of lithium ions.

In still yet another aspect, the present disclosure provides in some embodiments a membrane capacitor cell including the above-mentioned composite hydrophilic membrane electrode.

In still yet another aspect, the present disclosure provides in some embodiments a method for preparing a membrane capacitor cell, including providing a titanium plate, and forming an activated carbon counter electrode, an anion exchange membrane, a diaphragm, a composite hydrophilic membrane electrode and another titanium plate one on another on the titanium plate.

In a possible embodiment of the present disclosure, the activated carbon counter electrode is obtained through: adding activated carbon and polyvinylidene fluoride into N,N-dimethylacetamide, stirring a resultant solution evenly to obtain an activated carbon counter electrode slurry, applying the activated carbon counter electrode slurry onto a titanium plate, and drying the activated carbon counter electrode slurry; or adding activated carbon into an aqueous solution of polyvinyl alcohol, adding glutaric dialdehyde into the aqueous solution, stirring a resultant solution evenly to obtain an activated carbon counter electrode slurry, applying the activated carbon counter electrode slurry onto a titanium plate, and drying the activated carbon counter electrode slurry.

The present disclosure at least has the following beneficial effects.

(1) The method for preparing the composite hydrophilic membrane electrode includes: mixing Li₂CO₃ with TiO₂ evenly to obtain the mixture, and baking the mixture to obtain the Li₂TiO₃ precursor; mixing the Li₂TiO₃ precursor with graphene oxide evenly to obtain the Li₂TiO₃/graphene oxide composite material; calcining the Li₂TiO₃/graphene oxide composite material to obtain the Li₂TiO₃/reduced graphene oxide composite material; modifying the Li₂TiO₃/reduced graphene oxide composite material with tannic acid to obtain the modified active electrode material; and mixing the modified active electrode material with the solvent to obtain the active electrode slurry, applying the active electrode slurry onto the titanium plate, and baking the active electrode slurry to obtain the composite hydrophilic membrane electrode. According to the method in the embodiments of the present disclosure, it is able to increase the conductivity of the titanium ion sieve through the doped reduced graphene oxide. In addition, through the doped reduced graphene oxide, it is able to disperse the titanium ion sieves evenly, i.e., prevent the titanium ion sieves from being gathered, thereby to enable the ions to be transferred rapidly in the electrode material and be in full contact with the ion sieve. Moreover, due to the aggregation of tannic acid/polyamine on a surface, it is able to improve the hydrophilicity of the titanium ion sieve and increase the transmittability of the lithium ions, thereby to remarkably improve the lithium extraction capacity. Furthermore, the membrane electrode is prepared using the hydrophilic adhesive, i.e., polyvinyl alcohol, so it is able to improve the hydrophilicity of the membrane electrode, thereby to further improve the lithium extraction capacity and increase an adsorption rate.

(2) When the membrane capacitor cell in the embodiments of the present disclosure is used to extract the lithium ions in a lithium solution at a low concentration, it takes 2 hours to achieve adsorption equilibrium and takes 1 hour to achieve desorption equilibrium, as compared with the related art where it usually takes 8 hours to 12 hours, or even more, to achieve the adsorption equilibrium.

### BRIEF DESCRIPTION OF THE DRAWINGS

FIG. 1 is an X-ray diffraction (XRD) diagram of HTO/RGO-TA and a Li₂TiO₃ standard card in Example 4 according to one embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure. Actually, the embodiments are provided so as to facilitate the understanding of the scope of the present disclosure.

### Example 1

The present disclosure provides in this example a method for preparing a composite hydrophilic membrane electrode, which includes the following steps.

Step 1: mixing Li₂CO₃ with TiO₂ evenly at a molar ratio of 1.9:2 to obtain a mixture, and baking the mixture in a Muffle furnace at a temperature of 700° C. for 7 hours to obtain a Li₂TiO₃ precursor.

Step 2: mixing the Li₂TiO₃ precursor with graphene oxide evenly at a mass ratio of 10:1 to obtain a Li₂TiO₃/graphene oxide composite material.

Step 3: calcining the Li₂TiO₃/graphene oxide composite material in a nitrogen atmosphere at a temperature of 600° C. for 1 hour to obtain a Li₂TiO₃/reduced graphene oxide composite material.

Step 4: treating the Li₂TiO₃/reduced graphene oxide composite material with 0.3 mol/L hydrochloric acid at a temperature of 50° C. for 10 hours, adding the Li₂TiO₃/reduced graphene oxide composite material into a Tris buffer solution with a pH value of 8.0, dispersing a resultant solution through ultrasonic wave for 30 minutes, adding tannic acid and diethylenetriamine into the resultant solution, stirring a resultant mixture for 3 hours, subjecting the resultant mixture to centrifugal treatment, and washing the resultant mixture to obtain a modified active electrode material. The Tris buffer solution is an aqueous solution of tris(hydroxymethyl) aminomethane modified with hydrochloric acid, a mass ratio of the Li₂TiO₃/reduced graphene oxide composite material to the Tris buffer solution is 1:1, a mass ratio of tannic acid to diethylenetriamine is 4:1, and a mass ratio of the Li₂TiO₃/reduced graphene oxide composite material to tannic acid is 1:0.02.

Step 5: mixing the modified active electrode material with polyvinylidene fluoride and N,N-dimethylacetamide to obtain an active electrode slurry, applying the active electrode slurry onto a titanium plate, and baking the active electrode slurry in a vacuum oven at a temperature of 50° C. for 18 hours to obtain the composite hydrophilic membrane electrode. The modified active electrode material, polyvinylidene fluoride and N,N-dimethylacetamide are mixed at a mass ratio of 8:1:48.

The present disclosure further provides in this example a composite hydrophilic membrane electrode for the extraction of lithium ions.

The present disclosure further provides in this example a membrane capacitor cell including the composite hydrophilic membrane electrode. The membrane capacitor cell is used to extract lithium ions.

The present disclosure further provides in this example a method for preparing the membrane capacitor unit, which includes providing a titanium plate, and forming an activated carbon counter electrode, an anion exchange membrane, a diaphragm, a composite hydrophilic membrane electrode and another titanium plate one on another on the titanium plate.

The activated carbon counter electrode is obtained through: adding activated carbon and polyvinylidene fluoride into N,N-dimethylacetamide, stirring a resultant solution evenly to obtain an activated carbon counter electrode slurry, applying the activated carbon counter electrode slurry onto a titanium plate, and drying the activated carbon counter electrode slurry.

### Example 2

The present disclosure provides in this example a method for preparing a composite hydrophilic membrane electrode, which includes the following steps.

Step 1: mixing Li₂CO₃ with TiO₂ evenly at a molar ratio of 2.2:2 to obtain a mixture, and baking the mixture at a temperature of 780° C. for 10 hours to obtain a Li₂TiO₃ precursor.

Step 2: mixing the Li₂TiO₃ precursor with graphene oxide evenly at a mass ratio of 50:1 to obtain a Li₂TiO₃/graphene oxide composite material.

Step 3: calcining the Li₂TiO₃/graphene oxide composite material in a nitrogen atmosphere at a temperature of 700° C. for 3 hours to obtain a Li₂TiO₃/reduced graphene oxide composite material.

Step 4: treating the Li₂TiO₃/reduced graphene oxide composite material with 0.5 mol/L hydrochloric acid at a temperature of 80° C. for 12 hours, adding the Li₂TiO₃/reduced graphene oxide composite material into a Tris buffer solution with a pH value of 8.0, dispersing a resultant solution through ultrasonic wave for 60 minutes, adding tannic acid and diethylenetriamine into the resultant solution, stirring a resultant mixture for 6 hours, subjecting the resultant mixture to centrifugal treatment, and washing the resultant mixture to obtain a modified active electrode material. The Tris buffer solution is an aqueous solution of tris(hydroxymethyl) aminomethane modified with hydrochloric acid, a mass ratio of the Li₂TiO₃/reduced graphene oxide composite material to the Tris buffer solution is 1:2.5, a mass ratio of tannic acid to diethylenetriamine is 4:1, and a mass ratio of the Li₂TiO₃/reduced graphene oxide composite material to tannic acid is 1:0.5.

Step 5: mixing the modified active electrode material with polyvinylidene fluoride and N,N-dimethylacetamide to obtain an active electrode slurry, applying the active electrode slurry onto a titanium plate, and baking the active electrode slurry in a vacuum oven at a temperature of 60° C. for 24 hours to obtain the composite hydrophilic membrane electrode. The modified active electrode material, polyvinylidene fluoride and N,N-dimethylacetamide are mixed at a mass ratio of 200:1:50.

The present disclosure further provides in this example a composite hydrophilic membrane electrode for the extraction of lithium ions.

The present disclosure further provides in this example a membrane capacitor cell including the composite hydrophilic membrane electrode. The membrane capacitor cell is used to extract lithium ions.

The present disclosure further provides in this example a method for preparing the membrane capacitor unit, which includes providing a titanium plate, and forming an activated carbon counter electrode, an anion exchange membrane, a diaphragm, a composite hydrophilic membrane electrode and another titanium plate one on another on the titanium plate.

The activated carbon counter electrode is obtained through: adding activated carbon into an aqueous solution of polyvinyl alcohol, adding glutaric dialdehyde into the aqueous solution, stirring a resultant solution evenly to obtain an activated carbon counter electrode slurry, applying the activated carbon counter electrode slurry onto a titanium plate, and drying the activated carbon counter electrode slurry.

### Example 3

The present disclosure provides in this example a method for preparing a composite hydrophilic membrane electrode, which includes the following steps.

Step 1: mixing Li₂CO₃ with TiO₂ evenly at a molar ratio of 2:2 to obtain a mixture, and baking the mixture at a temperature of 850° C. for 4 hours to obtain a Li₂TiO₃ precursor.

Step 2: mixing the Li₂TiO₃ precursor with graphene oxide evenly at a mass ratio of 30:1 to obtain a Li₂TiO₃/graphene oxide composite material.

Step 3: calcining the Li₂TiO₃/graphene oxide composite material in a nitrogen atmosphere at a temperature of 500° C. for 2 hours to obtain a Li₂TiO₃/reduced graphene oxide composite material.

Step 4: treating the Li₂TiO₃/reduced graphene oxide composite material with 0.1 mol/L hydrochloric acid at a temperature of 65° C. for 8 hours, adding the Li₂TiO₃/reduced graphene oxide composite material into a Tris buffer solution with a pH value of 8.0, dispersing a resultant solution through ultrasonic wave for 45 minutes, adding tannic acid and diethylenetriamine into the resultant solution, stirring a resultant mixture for 1 hour, subjecting the resultant mixture to centrifugal treatment, and washing the resultant mixture to obtain a modified active electrode material. The Tris buffer solution is an aqueous solution of tris(hydroxymethyl) aminomethane modified with hydrochloric acid, a mass ratio of the Li₂TiO₃/reduced graphene oxide composite material to the Tris buffer solution is 1:1.8, a mass ratio of tannic acid to diethylenetriamine is 4:1, and a mass ratio of the Li₂TiO₃/reduced graphene oxide composite material to tannic acid is 1:1.

Step 5: mixing the modified active electrode material with polyvinylidene fluoride and N,N-dimethylacetamide to obtain an active electrode slurry, applying the active electrode slurry onto a titanium plate, and baking the active electrode slurry in a vacuum oven at a temperature of 55° C. for 18 hours to obtain the composite hydrophilic membrane electrode. The modified active electrode material, polyvinylidene fluoride and N,N-dimethylacetamide are mixed at a mass ratio of 8:1:48.

The present disclosure further provides in this example a composite hydrophilic membrane electrode for the extraction of lithium ions.

The present disclosure further provides in this example a membrane capacitor cell including the composite hydrophilic membrane electrode. The membrane capacitor cell is used to extract lithium ions.

The present disclosure further provides in this example a method for preparing the membrane capacitor unit, which includes providing a titanium plate, and forming an activated carbon counter electrode, an anion exchange membrane, a diaphragm, a composite hydrophilic membrane electrode and another titanium plate one on another on the titanium plate.

The activated carbon counter electrode is obtained through: adding activated carbon into an aqueous solution of polyvinyl alcohol, adding glutaric dialdehyde into the aqueous solution, stirring a resultant solution evenly to obtain an activated carbon counter electrode slurry, applying the activated carbon counter electrode slurry onto a titanium plate, and drying the activated carbon counter electrode slurry

### Example 4

The present disclosure provides in this example a method for preparing a composite hydrophilic membrane electrode, which includes the following steps.

Step 1: adding Li₂CO₃ and TiO₂ (anatase) at a molar ratio of 2:2 into an ethanol solution to obtain a mixture, dispersing the mixture evenly through ultrasonic wave, filtering the mixture to obtain a filtered liquid, drying the filtered liquid to obtain a mixture in the form of powder, and baking the mixture at a temperature of 750° C. for 10 hours to obtain a Li₂TiO₃ precursor (LTO).

Step 2: mixing the Li₂TiO₃ precursor with a graphene oxide dispersion evenly, filtering a resultant solution to obtain a filtered liquid, and drying the filtered liquid to obtain the Li₂TiO₃/graphene oxide composite material (LTO/GO). A mass ratio of the Li₂TiO₃ precursor to graphene oxide is 30:1, and the graphene oxide dispersion is an ethanol dispersion containing graphene oxide.

Step 3: calcining the Li₂TiO₃/graphene oxide composite material in a nitrogen atmosphere at a temperature of 600° C. for 2 hours to obtain a Li₂TiO₃/reduced graphene oxide composite material (LTO/RGO).

Step 4: treating the Li₂TiO₃/reduced graphene oxide composite material with 0.3 mol/L hydrochloric acid at a temperature of 70° C. for 10 hours, adding the Li₂TiO₃/reduced graphene oxide composite material into a Tris buffer solution with a pH value of 8.0, dispersing a resultant solution through ultrasonic wave for 45 minutes, adding tannic acid and diethylenetriamine into the resultant solution, stirring a resultant mixture for 3 hours, subjecting the resultant mixture to centrifugal treatment, and washing the resultant mixture to obtain a modified active electrode material (HTO/RGO-TA). The Tris buffer solution is an aqueous solution of tris(hydroxymethyl) aminomethane modified with hydrochloric acid, a mass ratio of the Li₂TiO₃/reduced graphene oxide composite material to the Tris buffer solution is 1:1.8, a mass ratio of tannic acid to diethylenetriamine is 4:1, and a mass ratio of the Li₂TiO₃/reduced graphene oxide composite material to tannic acid is 1:0.5.

Step 5: mixing the modified active electrode material with glutaric dialdehyde and a polyvinyl alcohol solution to obtain an active electrode slurry, applying the active electrode slurry onto a titanium plate, and baking the active electrode slurry in a vacuum oven at a temperature of 55° C. for 12 hours to obtain the composite hydrophilic membrane electrode. The modified active electrode material, glutaric dialdehyde and polyvinyl alcohol are mixed at a mass ratio of 200:1:50. The polyvinyl alcohol solution is obtained through dissolving 0.125 g polyvinyl alcohol in 1 ml to 5 ml water, i.e., the polyvinyl alcohol solution has a concentration of 0.025 g/ml to 0.125 g/ml.

The present disclosure further provides in this example a composite hydrophilic membrane electrode for the extraction of lithium ions.

The present disclosure further provides in this example a membrane capacitor cell including the composite hydrophilic membrane electrode. The membrane capacitor cell is used to extract lithium ions.

The present disclosure further provides in this example a method for preparing the membrane capacitor unit, which includes providing a titanium plate, and forming an activated carbon counter electrode, an anion exchange membrane, a diaphragm, a composite hydrophilic membrane electrode and another titanium plate one on another on the titanium plate.

The activated carbon counter electrode is obtained through: adding activated carbon into an aqueous solution of polyvinyl alcohol, adding glutaric dialdehyde into the aqueous solution, stirring a resultant solution evenly to obtain an activated carbon counter electrode slurry, applying the activated carbon counter electrode slurry onto a titanium plate, and drying the activated carbon counter electrode slurry.

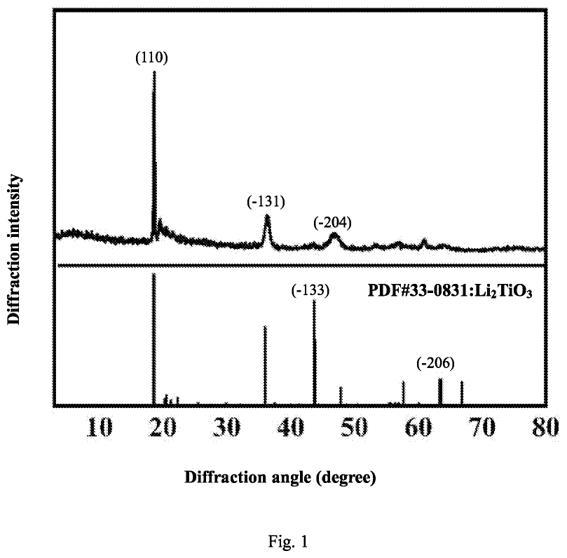

FIG. 1 is an XRD diagram of HTO/RGO-TA and a Li₂TiO₃ standard card according to one embodiment of the present disclosure, where an upper curve represents HTO/RGO-TA, and a lower curve represents the Li2TiO3 standard card PDF #33-0831. As shown in FIG. 1, in the curve for HTO/RGO-TA, there is an obvious offset at (110), and diffraction peaks at (−131) and (−204) widen, because of different bonding modes of Li⁺ and H⁺ at a Ti—O layer. To be specific, during the elution with hydrochloric acid, a unit cell is shrunk, so ionic exchange occurs between H⁺ with a smaller ionic radius and Li⁺ with a larger ionic radius. At (−133) and (−206), peaks disappear after the elution of a crystal plane with hydrochloric acid, and it means that Li⁺ has been extracted successfully from LTO.

### Example 5

The present disclosure provides in this example a method for preparing a composite hydrophilic membrane electrode, which differs from that in Example 4 merely in Step 5. To be specific, in this example, Step 5 includes mixing the modified active electrode material with polyvinylidene fluoride and N,N-dimethylacetamide to obtain an active electrode slurry, applying the active electrode slurry onto a titanium plate, and baking the active electrode slurry in a vacuum oven at a temperature of 55° C. for 12 hours to obtain the composite hydrophilic membrane electrode. The modified active electrode material, polyvinylidene fluoride and N,N-dimethylacetamide are mixed at a mass ratio of 8:1:48.

### Comparative Example 1

The present disclosure provides in this comparative example a method for preparing a membrane electrode, which differs from the method in Example 4 merely in that no reduced graphene oxide is doped, i.e., Steps 2 and 3 are not included, and instead, the Li₂TiO₃/reduced graphene oxide composite material in Step 4 is replaced with the Li₂TiO₃ precursor in Step 1. To be specific, the method includes the following steps.

Step 1: adding Li₂CO₃ and TiO₂ (anatase) at a molar ratio of 2:2 into an ethanol solution to obtain a mixture, dispersing the mixture evenly through ultrasonic wave, filtering the mixture to obtain a filtered liquid, drying the filtered liquid to obtain a mixture in the form of powder, and baking the mixture at a temperature of 750° C. for 10 hours to obtain a layered Li₂TiO₃ precursor (LTO).

Step 2: treating the Li₂TiO₃ precursor with 0.3 mol/L hydrochloric acid at a temperature of 70° C. for 10 hours, adding the Li₂TiO₃ precursor into a Tris buffer solution with a pH value of 8.0, dispersing a resultant solution through ultrasonic wave for 45 minutes, adding tannic acid and diethylenetriamine into the resultant solution, stirring a resultant mixture for 3 hours, subjecting the resultant mixture to centrifugal treatment, and washing the resultant mixture to obtain a modified active electrode material. The Tris buffer solution is an aqueous solution of tris(hydroxymethyl) aminomethane modified with hydrochloric acid, a mass ratio of the Li₂TiO₃ precursor to the Tris buffer solution is 1:1.8, a mass ratio of tannic acid to diethylenetriamine is 4:1, and a mass ratio of the Li₂TiO₃ precursor to tannic acid is 1:0.5.

Step 3: mixing the modified active electrode material with glutaric dialdehyde and a polyvinyl alcohol solution to obtain an active electrode slurry, applying the active electrode slurry onto a titanium plate, and baking the active electrode slurry in a vacuum oven at a temperature of 55° C. for 12 hours to obtain the composite hydrophilic membrane electrode.

### Comparative Example 2

The present disclosure provides in this comparative example a method for preparing a membrane electrode, which differs from the method in Example 4 merely in that tannic acid is not used, i.e., Step 4 is not included, and instead, the Li₂TiO₃/reduced graphene oxide composite material in Step 3 is directly used to form the active electrode slurry. To be specific, the method includes the following steps.

Step 1: adding Li₂CO₃ and TiO₂ (anatase) at a molar ratio of 2:2 into an ethanol solution to obtain a mixture, dispersing the mixture evenly through ultrasonic wave, filtering the mixture to obtain a filtered liquid, drying the filtered liquid to obtain a mixture in the form of powder, and baking the mixture at a temperature of 750° C. for 10 hours to obtain a layered Li₂TiO₃ precursor (LTO).

Step 2: mixing the Li₂TiO₃ precursor with a graphene oxide dispersion evenly, filtering a resultant solution to obtain a filtered liquid, and drying the filtered liquid to obtain a Li₂TiO₃/graphene oxide composite material. A mass ratio of the Li₂TiO₃ precursor to graphene oxide is 30:1, and the graphene oxide dispersion is an ethanol dispersion containing graphene oxide.

Step 3: calcining the Li₂TiO₃/graphene oxide composite material in a nitrogen atmosphere at a temperature of 600° C. for 2 hours to obtain a Li₂TiO₃/reduced graphene oxide composite material (LTO/RGO).

Step 4: mixing the Li₂TiO₃/reduced graphene oxide composite material with glutaric dialdehyde and a polyvinyl alcohol solution to obtain an active electrode slurry, applying the active electrode slurry onto a titanium plate, and baking the active electrode slurry in a vacuum oven at a temperature of 55° C. for 12 hours to obtain the composite hydrophilic membrane electrode.

### Effect Comparative Example

The following test is performed so as to validate a technical effect of the method for preparing the composite hydrophilic membrane electrode in the embodiments of the present disclosure.

Membrane capacitor cells are prepared through the method in Example 4 using the composite hydrophilic membrane electrodes in Examples 1 to 5 and Comparative Examples 1 and 2, and then used to extract and recycle Li⁺ in a solution at a concentration of 303 mg/L (pH=10.98). To be specific, a 1.2V voltage is applied to the solution for the extraction of Li⁺, and then a 1.2V voltage is applied reversely to release Li⁺ into deionized water for recycling. Next, a lithium extraction capacity and a concentration of the solution after the extraction are measured through an electrical conductivity meter, and an extraction rate is calculated. Next, a concentration of the solution after the recycling is measured through the electrical conductivity meter, and a recycling rate is calculated. Then, a water contact angle of the membrane electrode is measured through a water contact angle meter.

The extraction rate is calculated through the extraction rate=[1−(C2/C1)]*100%, where C1 (mg/L) is a concentration of the original solution, and C2 (mg/L) is the concentration of the solution after the extraction.

Results of the test are shown in the following table.

| | Lithium | | | |
|---|---|---|---|---|
| | extraction | | | |
| | capacity | Extraction | Recycling | Water contact |
| Serial number | (mg/g) | rate (%) | rate (%) | angle (°) |
| Example 1 | 18.1 | 14.9 | 82.1 | 72.5 |
| Example 2 | 19.0 | 15.6 | 81.4 | 70.1 |
| Example 3 | 19.8 | 16.4 | 82.7 | 68.3 |
| Example 4 | 25.2 | 20.8 | 82.8 | 50.9 |
| Example 5 | 22.1 | 18.2 | 82.0 | 62.2 |
| Comparative | 14.6 | 11.1 | 81.3 | 73.9 |
| Example 1 | | | | |
| Comparative | 16.1 | 13.3 | 82.2 | 88.5 |
| Example 2 | | | | |

As shown in the above table, the composite hydrophilic membrane electrode obtained through the method in the embodiments of the present disclosure has excellent conductivity, and the lithium extraction capacity is high. Through comparing Examples 1 to 5 with Comparative Example 1, when reduced graphene oxide is doped, it is able to improve the conductivity of the membrane electrode. In addition, it is able to prevent the aggregation of the ion sieve particles, and disperse the titanium ion sieves evenly, thereby to enable the ions to transfer rapidly in the electrode material and be in full contact with the ion sieve, and remarkably increase the lithium extraction efficiency. Through comparing Examples 1 to 5 with Comparative Example 2, when the composite material is modified with tannic acid, it is able to improve the hydrophilicity. The smaller the water contact angle, the better the hydrophilicity, so it is able to increase a degree of enrichment of the ions on a surface of the electrode and improve the mobility of the lithium ions, thereby to remarkably increase the lithium extraction efficiency. Through comparing Examples 1 to 3, 5 with Example 4, when polyvinyl alcohol is used as an adhesive, it is able to improve the hydrophilicity of the membrane electrode, increase the degree of enrichment of the ions on the surface of the electrode and improve the mobility of the lithium ions, thereby to further increase the lithium extraction efficiency.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A method for preparing a composite hydrophilic membrane electrode, comprising:
mixing Li₂CO₃ with TiO₂ evenly to obtain a mixture, and baking the mixture to obtain a Li₂TiO₃ precursor;
mixing the Li₂TiO₃ precursor with graphene oxide evenly to obtain a Li₂TiO₃/graphene oxide composite material;
calcining the Li₂TiO₃/graphene oxide composite material to obtain a Li₂TiO₃/reduced graphene oxide composite material;
modifying the Li₂TiO₃/reduced graphene oxide composite material with tannic acid to obtain a modified active electrode material; and
mixing the modified active electrode material with a solvent to obtain an active electrode slurry, applying the active electrode slurry onto a titanium plate, and baking the active electrode slurry to obtain the composite hydrophilic membrane electrode.

2. The method according to claim 1, wherein a molar ratio of Li₂CO₃ to TiO₂ is in a range of 1.9:2 to 2.2:2, and the mixture is baked at a temperature of 700° C. to 850° C. for 4 hours to 10 hours.

3. The method according to claim 1, wherein a mass ratio of the Li₂TiO₃ precursor to graphene oxide is in a range of 10:1 to 50:1, and graphene oxide is a graphene oxide dispersion.

4. The method according to claim 1, wherein the Li₂TiO₃/graphene oxide composite material is calcined in a nitrogen atmosphere at a temperature of 500° C. to 700° C. for 1 hour to 3 hours.

5. The method according to claim 1, wherein prior to modifying the Li₂TiO₃/reduced graphene oxide composite material with tannic acid, the Li₂TiO₃/reduced graphene oxide composite material is processed with 0.1 mol/L to 0.5 mol/L hydrochloric acid at a temperature of 50° C. to 80° C. for 8 hours to 12 hours;
the modifying the Li₂TiO₃/reduced graphene oxide composite material with tannic acid comprises adding the Li₂TiO₃/reduced graphene oxide composite material into a Tris buffer solution with a pH value of 8.0, dispersing a resultant solution through ultrasonic wave for 30 minutes to 60 minutes, adding tannic acid and diethylenetriamine into the resultant solution to obtain a mixture, stirring the mixture for 1 hour to 6 hours, subjecting the mixture to centrifugal treatment, and washing the mixture to obtain the modified active electrode material; and
a mass ratio of tannic acid to diethylenetriamine is 4:1.

6. A composite hydrophilic membrane electrode prepared by the method according to claim 1.

7. Use of the composite hydrophilic membrane electrode according to claim 6 in extraction of lithium ions.

8. A membrane capacitor cell, comprising the composite hydrophilic membrane electrode according to claim 6.

9. A method for preparing the membrane capacitor cell according to claim 8, comprising:
providing a titanium plate, and
forming an activated carbon counter electrode, an anion exchange membrane, a diaphragm, a composite hydrophilic membrane electrode and another titanium plate one on another on the titanium plate.

10. The method according to claim 9, wherein the activated carbon counter electrode is obtained through:
adding activated carbon and polyvinylidene fluoride into N,N-dimethylacetamide, stirring a resultant solution evenly to obtain an activated carbon counter electrode slurry, applying the activated carbon counter electrode slurry onto a titanium plate, and drying the activated carbon counter electrode slurry; or
adding activated carbon into an aqueous solution of polyvinyl alcohol, adding glutaric dialdehyde into the aqueous solution, stirring a resultant solution evenly to obtain an activated carbon counter electrode slurry, applying the activated carbon counter electrode slurry onto a titanium plate, and drying the activated carbon counter electrode slurry.
